(19) United States
(12) Patent Application Publication
(10) Pub. No.: US 2025/0035058 A1
(43) Pub. Date: Jan. 30, 2025

(54) VARIABLE MODE ENGINE CONTROL

(71) Applicant: PAUL ROBERT OTTO, BIRMINGHAM, AL (US)

(72) Inventor: PAUL ROBERT OTTO, BIRMINGHAM, AL (US)

(73) Assignee: PAUL ROBERT OTTO, BIRMINGHAM, AL (US)

(21) Appl. No.: 18/357,245

(22) Filed: Jul. 24, 2023

(51) Int. Cl. F02D 41/00; F02D 13/02; F02D 13/06

(52) U.S. Cl. CPC F02D 41/0087; F02D 13/0242; F02D 13/06; F02D 2200/101; F02D 2250/34; F02D 2250/36

(57) ABSTRACT

Changing a method to control engine operation is disclosed. The invention/system relates to an apparatus of an engine. We'll provide a similar process for how a mechanical system runs. Using today's method, engines have dedicated operation to use fuel constantly. An operating system using the present mechanical method has problems. Engines waste most of the fuel. The present method has an explosion (pulse) when an engine rotates 90°. It's about 3″ apart along the ground in high gear. Engines fire before top dead center (TDC) but by the time the crank rotates to 90° after TDC pressure reduces to about 300 psi. Pressure drops ½ (600 drops to 300 psi in labs) after explosions. Rapid cooling from 900° F. depletes pressure. Lab data shows near 300 psi at 90° after TDC. Videos show a decrease in 100ths of a sec.

An electronic system makes dynamic operation changes. A lighter & smaller engine could be available when timing belts or chains, tension adjusters, camshafts, rocker assemblies, pushrods, lifters, & valve springs are removed. Valve springs aren't needed with the modification being developed. It's a discovery. Removing valve springs allows valves to move with limited resistance. Solenoids could move valves without a cam or hydraulic system's force.

NOTE: This technology has variable modes for valves, fuel injectors and sparks. A single computer is used to change operation of each mode. A translating algorithm controls a computing system.

Fact—Fuel and air create fire caused by a spark plug to heat air in cylinders.

In this portion several key technologies are explained in detail to show the benefits of each. This is a special electronic process for 4 stroke engines using a flywheel magnet, rpm sensor, $25 electric solenoids (actuators) to move valves & a computing system to improve performance. Electric valve solenoids change when valves open or close. Intermittent duty is considered a vital improvement. A special process is available using a computing system because changing modes could reduce fuel use. Coil actuators (solenoids) are sent current from a computing system master control. Computing systems use DC current. Coils move valves the same time a mechanical cam moves them, plus allow more action changes. Coils can switch magnetic flux direction. Mode changes could be anytime using an electronic system. A computing system advance allows simple improvements because we control the combustion cycle a special way. Variable valve actuation systems offer a different level of control and reliability of the combustion cycle.

We'd improve emissions with lower NOx operation using any fuel. When vehicles move at a constant speed fuel injectors could be deactivated. Electronic valve control improves engine balance & has more precise timing with actuators. Valves use electro-magnetic solenoids because valves may be adaptive and preferred to reduce using fuel. Engines may freely spin having exhaust valves open (no back pressure). Intake valves may be open or closed. An advantage is a cylinder won't use fuel when it isn't activated if the computing system doesn't request pulses. Fuel injectors aren't spraying micro-mist.

A solid state (micro-processor) computing system for a 4 stroke internal combustion engine controls the operating process a unique way. An electronic process using solenoids requires less fuel. Changing spark timing improves output force. The system is upgradeable over the engine's lifetime. We'll benefit from an electrical method that could improve engines. Engine mechanisms depend on cams to move valves currently. Both intake and exhaust valves can be opened and closed at any desired crankshaft angle with an adaptable computing system algorithm. This flexibility enables an engine to have lower fuel consumption and emission numbers, while still delivering increased torque and horsepower.

Engines would sell easily & faster when purchasers see the adaptability advances over engines we have now because those today are cam controlled. There is no liability to vehicle occupants from the low voltage electronic systems.

Here's a technical explanation of when air is 900° it's 1,200 times as large=600 psi in a cylinder. Denser fuel (diesel) raises the temperature higher. 900 psi pushes harder. A higher temperature gives a higher pressure. An improvement would be a way to ignite diesel using a catalyst like LP (barbeque gas) or gasoline. They could easily ignite diesel micro mist without the mandated pressure used now. Diesel engines develop 50% more HP for each drop of fuel. Diesel is 150 HP compared to 100 HP for gasoline.

Hit and miss engines (white gas) from 1860 to 1940's maintained a constant rpm. They were utility machines for farms before electricity & electric motors became available after WW2. A special principle makes an idea better. Hit & miss is gone but the principle can be used to raise mpg. There is an advance explained next that has problems getting into use because the technical approach is incorrect.

Swedish company “Freevalve AB” developed a “cam-less” system and successfully implemented it on a SAAB 9-5, 2.3 t engine in 2008. Freevalve design is being developed. It's hard to transition deactivated cylinders to get power from them. Hydraulic fluid flows through solenoids to open & close each valve. An air pump makes pneumatic pressure to cushion closing valves of the design. Engines can't change modes at higher rpm's due to their design flaws.

Chinese company Qoros, uses the freevalve technology. Valve timing can be adjusted freely from valve to valve and cycle to cycle. It allows many lift events or no events (deactivating cylinders). Camless systems today use too much power and they're too loud. High speed accuracy, temperature sensitivity, high cost, packaging issues and unsafe operation are from technicians not fixing problems (engines lose electricity). For Qoros 3 engines in 2016, standard electronics weren't developed and can't be installed near the engine. Technicians still work on electronics since they couldn't find solutions in 12 years.

Advantages are extensive (comprehensive) when eliminating a mechanical valve train. Our design uses computing system valve control and can adjust ignition timing. For engines in service now conversions to adaptive operation can be completed without cylinder head removal. Conversions take 3 hours to permanently increase mpg and HP, because combustion is controlled.

Let's see reasons for the improvements. Higher pressure that didn't dissipate (decrease) is available to push harder on pistons and increase rpm. 600 psi is better suited then rather than when a piston isn't moving at TDC. The higher pressure is used. An engineering innovation was discovered. Much was wasted before a piston moves fast.

There's more to our design. Ignition is before pistons reach the top now. Pistons aren't moving when they are at the top of the cylinders. What if you could increase engine HP? A computer's master control center increases HP. Our software calculates the correct spark timing. Plugs will spark at an engineered time of the cycle occurring when pistons are moving fast . . . . It is a better way. An important advantage is there is no knock from any fuel when sparks are after TDC so it's GOOD to vary sparks. When variable timing could have a range of 75° an engine can adapt to conditions. Computing systems can control timing to dynamically improve engine power.

Dedicated operation generates power to start moving, accelerate, or climb a slope. The rated power of engines is used only for those times. Here are examples of when you need power. We evaluate how long cars take to reach 40 mph from zero. It's 10 seconds. To reach cruising speed (70 mph) from zero, using full throttle it's about 30 seconds. To pass someone using full throttle is 10 seconds. To climb a slope, takes about 30 seconds using full throttle. Power is used for short amounts of time for those tasks.

Very short periods of time are compared to how long a trip is. 30 minutes is 60 sec.×30 min.=1,800 seconds so 10 seconds @ full throttle is a tiny 0.0055 (55 thousandths or 0.55%). 30 sec. is 3×0.0055=0.0165 (1.6%). Moving @ a steady speed engines don't use the maximum power available. You don't change your speed. You move at a steady speed 99% of the trip. 99% of the pulses aren't needed moving at a steady speed. A computer activates valves and a fuel injector for a pulse to spin the engine faster.

There's no way to decrease using fuel now. Today engines have a cam controlled valve train. Back pressure resists engine rotation. Pulses are made every 90° now. Imagine if you had a system to fix the back pressure problem. An electronic control system stops activating valves unless the computer system Master Control needs a power pulse. The developer discovered how to spin engines freely with intermittent pulses (backpressure is gone so few are needed). That discovery reduces the number of explosions so fuel mileage can improve.

There's a valuable improvement you'll see. Let's learn the concept explanation. It is beneficial. Transportation technologies may have free spinning engines. Let's use an ideal example. Vehicles move the same speed 99% of each trip. Recall isn't a vehicle moving the same speed 99% of a trip? Multiply 100 times our current mileage to get a result. Getting 100×25 mpg mileage: a car could get 2,500 mpg. It has to be proven as a fact. In actual practice, it could be lower. Now vehicles refill every 300 miles.

Engines may get an unknown technology that's being developed. A solution is using a new system. Engines could freely spin. If the computer Master Control mandates a pulse then one cylinder's valves move to prepare for ignition. They activate intermittently per conditions for one explosion to raise rpm. The computer Master Control does it.

An advantage is a cylinder won't use fuel when it isn't activated if the computing system doesn't request pulses. “Free-spinning is similar to coasting down a hill. Less fuel use can benefit engines. The technology could improve transportation designs,” was proposed by Asst. Prof. Edward S. (tech mentor) at Samford University, Mech. Eng. Dept., in Birmingham, Al on Sep. 11, 2020.

I claim:

1. An operating system for an engine.

2. An operating system for an engine of claim 1, wherein, valve-train components named cylinder head valve springs, rocker assemblies, lifter rods, lifters, and cam shafts are not installed in said engine.

3. An operating system for an engine of claim 1, comprising, electro-magnet valve solenoids to replace named valve-train components to position valves open or closed, controlled by a computing system Master Control algorithm to calculate when to send electric current to said valve solenoids.

4. An operating system for an engine of claim 1, further comprising, a computing system Master Control opens exhaust valves for engineered periods intermittently so said engine spins without back pressure called free spinning until it calculates rpms are below an engineered range and activates one or many (paired) cylinders to increase rpms up to maintain an engineered range.

5. An operating system for an engine of claim 1, comprising, fuel injectors that could occasionally be deactivated with exhaust valves open until the computing system Master Control makes algorithm calculations to activate a cylinder or many (paired) cylinders to increase rpms into an engineered range.

6. An operating system for an engine of claim 1, further comprising, electronic components receive electric current from a computing system for empowering rapid mode changes to free spinning (deactivate) or activate a cylinder or many (paired) cylinders to maintain an engineered rpm.

7. An operating system for an engine of claim 1, comprising, alternative intermittent operation that could extend fuel (×100) to help reduce CO₂ and global warming.
A thesis for a PHD will promote research results about intermittent engine operation to media. Request for Examiner
If the examiner believes there is patentable subject matter disclosed in the application but does not feel the present claims are technically adequate, he is respectfully requested to write acceptable claims, pursuant to the Manual on Patent Application, Practice Section, per pro-se instructions, to expedite prosecution of the patent application.
